(19) United States
(12) Patent Application Publication
(10) Pub. No.: US 2026/0336739 A1
(43) Pub. Date: Oct. 29, 2026

(54) Connection Base Assembly for Bicycle and Backpack Having the Same

(71) Applicant: Jianming HUANG, Guangdong (CN)

(72) Inventor: Jianming HUANG, Guangdong (CN)

(21) Appl. No.: 19/731,014

(22) Filed: Jul. 4, 2026

Related U.S. Application Data
(63) Continuation of application No. 18/600,888, filed on Mar. 11, 2024, now Pat. No. 12,722,729.

(51) Int. Cl. B62J 9/27; A45F 3/04; B62J 9/26

(52) U.S. Cl. CPC B62J 9/27; A45F 3/04; B62J 9/26

(57) ABSTRACT

Provided are a connection base assembly for a bicycle and a backpack connection assembly having the connection base assembly. The connection base assembly comprises a base, a first mounting accessory, and a second mounting accessory. The base is used for fixing to a carrying device. The first mounting accessory is capable of switching between an extended state and a retracted state, and in the extended state, it is detachably connected to the second mounting accessory installed on a seat post of a bicycle, under-saddle connection structure, seat tube, or rear seat stay, so that a gap is formed between the carrying device and the seat post or bicycle frame. The backpack connection assembly further comprises an auxiliary connecting member provided on a backpack body to cooperate with a corresponding auxiliary connecting member on the bicycle to form a support structure.

### CROSS-REFERENCE TO RELATED APPLICATIONS

The present application is a continuation of U.S. patent application Ser. No. 18/600,888, filed on Mar. 1, 2024, titled “Backpack And Backpack Connecting Components,” the content of which is incorporated herein by reference in its entirety.

### TECHNICAL FIELD

The present application relates to the field of bag technology, and more particularly to a connection base assembly for a bicycle and a backpack connection assembly having the same.

### BACKGROUND

For carrying cargo on the rear of a bicycle, existing solutions typically involve installing a rear rack behind the seat post or on the rear of the frame, and then placing bags, boxes, or other load-carrying devices onto the rear rack. While rear racks provide load-bearing capacity, they generally increase vehicle weight, affect the bicycle's appearance, and may generate vibrations or abnormal noises during riding, which impacts the riding experience.

Currently, there are also solutions that secure tail bags, saddle bags, or other load-carrying devices behind the saddle, or near the seat post, seat tube, or rear seat stay using straps, clamps, external mounting brackets, or support rods integrated with and exposed on the load-carrying device. However, such structures are often inconvenient to install and remove, are not suitable for carrying while walking, and some load-carrying devices are prone to swaying, rotating, or sagging during riding. If the load-carrying device is positioned close to the seat post, it may also interfere with the inner or rear side of the rider's thighs.

Furthermore, for backpacks, boxes, or other carrying devices intended for daily carry, if the connection structure remains exposed on the outside of the carrying device for a long time, it can easily interfere with carrying, lifting, placing, or daily use in non-riding states.

### SUMMARY

The present application provides a connection base assembly for a bicycle and a backpack connection assembly having the connection base assembly to solve the problems raised in the background art. To achieve the above objectives, the present application adopts the following technical solutions:

A connection base assembly for a bicycle, including: a base, the base being configured for fixing to an interior, a bottom, a back, or any side of a carrying device; a first mounting accessory, the first mounting accessory being provided on the base, and the first mounting accessory being configured to be capable of switching between an extended state and a retracted state; and a second mounting accessory, the second mounting accessory being configured for mounting to a seat post, an under-saddle connection structure, a seat tube, or a rear seat stay of a bicycle. The first mounting accessory is detachably connected to the second mounting accessory in the extended state, and after the first mounting accessory is connected to the second mounting accessory, a gap is formed between the carrying device and the seat post; and the first mounting accessory is at least partially accommodated within the carrying device or the base, or attached to one side of the carrying device or the base, in the retracted state.

The present application further provides a backpack connection assembly, including: a backpack body; a base, the base being fixed to an interior, a bottom, a back, or any side of the backpack body; a first mounting accessory, the first mounting accessory being provided on the base, the first mounting accessory being configured to be switchable between an extended state and a retracted state; a second mounting accessory, the second mounting accessory being configured for mounting to a seat post or an under-saddle connection structure of a bicycle, the first mounting accessory being detachably connected to the second mounting accessory in the extended state, and a gap being formed between the backpack body and the seat post after the first mounting accessory and the second mounting accessory are connected; a first auxiliary connecting member provided on a first side of the backpack body, for detachably connecting with a corresponding auxiliary connecting member provided on a left side of the bicycle saddle; and a second auxiliary connecting member provided on a second side of the backpack body, for detachably connecting with a corresponding auxiliary connecting member provided on a right side of the bicycle saddle. A connection of the first auxiliary connecting member with the corresponding auxiliary connecting member, a connection of the second auxiliary connecting member with the corresponding auxiliary connecting member, and a connection of the first mounting accessory with the second mounting accessory together constitute a support structure of the backpack body.

The beneficial effects of the present application compared to the prior art are as follows:

By providing a base on the carrying device or backpack body, and a first mounting accessory on the base that can switch between an extended state and a retracted state, the carrying device or backpack may be quickly connected to a second mounting accessory on the seat post of a bicycle or under-saddle connection structure during riding, thereby achieving stable carrying without the need for an additional rear rack; after the first mounting accessory is connected to the second mounting accessory, a gap may be formed between the carrying device or backpack body and the seat post, reducing interference with the rider's legs and lowering the risk of swaying, rotating, or sagging during riding; after the carrying device or backpack is removed from the bicycle, the first mounting accessory may be at least partially stored within or attached to the base, reducing the impact of exposed connection structures on daily carrying, lifting, placing, and use, thus balancing quick-release stability when carrying loads on a bicycle with convenience in non-riding states. This ultimately achieves the core purpose of enabling backpack mounting on a bicycle without installing a rack, providing quick-release installation, and ensuring convenience for walking and daily use.

### BRIEF DESCRIPTION OF DRAWINGS

The drawings, which constitute a part of this application, are provided for a further understanding of the present application. The illustrative embodiments of the present application and the descriptions thereof are used to explain the present application and do not constitute an improper limitation thereof. In the drawings:

FIG. 1 is a structural schematic diagram of the backpack and backpack connection assembly provided by any one of Embodiments 1-3 of the present application;

FIG. 2 is a structural schematic diagram of the base of the backpack provided by any one of Embodiments 1-3 of the present application;

FIG. 3 is a schematic diagram of the backpack provided by Embodiment 4 of the present application in a connected state with a bicycle;

FIG. 4 is a schematic diagram of the backpack provided by Embodiment 4 of the present application in a separated state from a bicycle;

FIG. 5 is a schematic diagram of the backpack provided by another embodiment of the present application in a separated state from a bicycle.

Reference signs: 1—Backpack Body, 11—Connecting member A, 12—Connecting member B, 13—Connecting member C, 131—Sleeve, 14—Base, 141—Mounting Groove, 21—Connecting member a, 22—Connecting member b, 23—Connecting member c, 231—Clamping Hoop, 232—Strut, 31—Saddle, 32—Seat Post, 33—Seat Tube, 34—Rear Seat Stay.

### DESCRIPTION OF EMBODIMENTS

The technical solutions in the embodiments of the present disclosure will be clearly and completely described below with reference to the accompanying drawings in the embodiments of the present disclosure. It is apparent that the described embodiments are only a part of the embodiments of the present disclosure, rather than all of them. The following description of at least one exemplary embodiment is illustrative only and is in no way intended to limit the present disclosure and its applications or uses. Based on the embodiments of the present disclosure, all other embodiments obtained by those of ordinary skill in the art without creative efforts shall fall within the scope of protection of the present disclosure.

It should be noted that the terms used herein are only for describing specific embodiments and are not intended to limit the exemplary embodiments according to the present application. As used herein, unless the context clearly indicates otherwise, the singular forms are intended to include the plural forms as well. Furthermore, it should be understood that when the terms “comprise” and/or “include” are used in this specification, they indicate the presence of features, steps, operations, devices, components, and/or combinations thereof.

Unless specifically stated otherwise, the relative arrangement, numerical expressions, and numerical values of components and steps set forth in these embodiments do not limit the scope of the present disclosure. At the same time, it should be understood that for ease of description, the dimensions of the various parts shown in the drawings are not drawn according to actual proportional relationships. Techniques, methods, and equipment known to those of ordinary skill in the relevant art may not be discussed in detail, but where appropriate, such techniques, methods, and equipment should be considered as part of the authorized specification. In all examples shown and discussed herein, any specific values should be construed as illustrative only and not as limiting. Therefore, other examples of the exemplary embodiments may have different values. It should be noted that similar reference numerals and letters denote similar items in the following drawings, so once an item is defined in one drawing, it does not need to be further discussed in subsequent drawings.

In the following embodiments, for ease of explanation, the connecting member C13 may be understood as a first mounting accessory combined with the backpack body 1 or the base 14, and the connecting member c23 may be understood as a second mounting accessory used for installation on the seat post 32 of a bicycle or the connection structure under the saddle 31, the seat tube 33, or the seat stay 34. The connection between the first mounting accessory and the second mounting accessory may be configured as a quick-release connection, allowing the backpack body 1 to be removed from the bicycle as a whole; after the backpack body 1 is removed, the connecting member c23, the connecting member a21, and the connecting member b22 can remain on the bicycle or be removed from the bicycle as a whole as detachable accessories.

It should be noted that the connecting member A11, connecting member B12, connecting member C13, connecting member a21, connecting member b22, and connecting member c23 in this application are not limited to single parts, but may also be formed by a combination of one or more of a strap body, seat body, rod member, sleeve, hinge member, locking member, elastic member, buckle, gasket, and fastener, provided that they can achieve detachable connection, auxiliary support, gap maintenance, or anti-sway functions at the corresponding positions.

### Embodiment 1

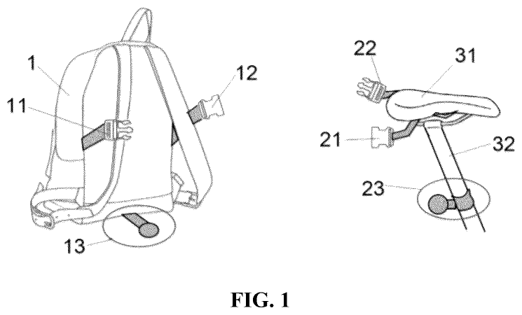

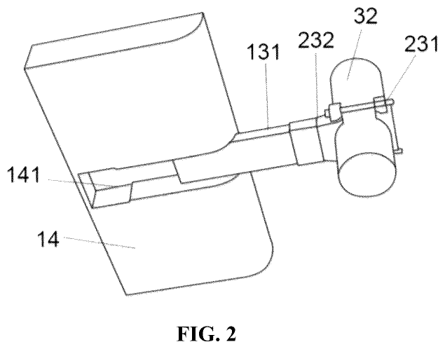

This embodiment provides a backpack, as shown in FIGS. 1 to 2, including a backpack body 1 and a connecting member C13 disposed at the bottom of the backpack body 1. The connecting member C13 is a first connecting member. The connecting member C13 may be deployed from or retracted into the backpack body 1, and when deployed, the connecting member C13 is detachably connected to a connecting member c23 disposed on a seat post 32 of a bicycle. The connecting member c23 is a second connecting member. After the connecting member C13 is connected to the connecting member c23, the backpack body 1 is securely fixed to the rear of the bicycle seat.

Specifically, the connecting member C13 is disposed at the bottom of the backpack body 1, where the bottom is the bottom surface of the backpack body 1 when it is in an upright position.

In some other embodiments, the connecting member C13 may also be disposed on the back of the backpack body 1, where the back is the side of the backpack body 1 that comes into contact with a user's back when carried.

In some other embodiments, the connecting member C13 may also be disposed on the front of the backpack body 1, where the front is the side opposite to the back.

In some other embodiments (not shown), the connecting member C13 may also be disposed on the bottom edge, lower back, lower front, left side, right side, or inside of the backpack body 1, on the outer fixing surface of the base 14, or on a reinforced fixing surface of the backpack body 1. When the connecting member C13 is disposed at a non-bottom position of the backpack body 1, it may be connected to the backpack body 1 via a reinforcing sheet, inner lining plate, rigid connection seat, or stitched reinforcing strap to distribute the connection load to a larger area of the backpack body 1, reducing local tearing or deformation.

When the connecting member C13 is in a retracted state within the backpack body 1, it may be completely stored in the mounting groove 141, or stored in an interlayer, pocket, flap, soft shielding sheet, or a receiving cavity formed by the base 14, or attached to one side of the backpack body 1 or the base 14. The aforementioned retracted state ensures that the connecting member C13 is not obviously exposed during daily carrying, thereby reducing the possibility of the connecting member C13 scratching or bumping against the user's back, clothing, or external objects.

In this embodiment, the connecting member C13 is extended from or retracted into the backpack body 1 in a telescopic manner. Specifically, the bottom of the backpack body 1 is provided with a mounting groove 141, and a sliding groove (not shown) parallel to its length direction is provided within the mounting groove 141. The sleeve 131 is slidably connected to the sliding groove, and the sleeve 131 can extend out of the mounting groove 141 along the sliding groove and be limited and locked in the extended state, so that the connecting member C13 can remain relatively fixed during cycling. When the sleeve 131 is retracted to the retracted state, the opening of the mounting groove 141 may be closed by a zipper, a flap, or a shielding sheet. Of course, in other embodiments, the movement mode of the connecting member C13 may also be other movement modes, such as folding or rotating; folding refers to the connecting member C13 rotating along a direction orthogonal to the surface where it is located, while rotating refers to the connecting member C13 rotating along a direction parallel to the surface where it is located.

In some embodiments (not shown), the telescopic fit between the sleeve 131 and the mounting groove 141 may be realized by a linear slide rail, a T-shaped sliding groove, a dovetail groove, a U-shaped guide groove, a limiting rib, or a guide roller. The sleeve 131 may be a single telescopic rod, parallel double telescopic rods, telescopic rods sleeved inside and outside each other, or a profiled sleeve with reinforcing ribs. When parallel double telescopic rods are used, the two telescopic rods may be arranged at intervals in the transverse direction of the backpack body 1 and connected by a transverse connecting portion to improve torsional strength and left-right anti-sway capability.

The limiting and locking of the sleeve 131 in the extended position may be realized by a positioning hole and an elastic pin, a marble and a positioning groove, an elastic buckle, a knob locking member, an eccentric pressing member, a push-type latch, a bolt, or a magnetic auxiliary positioning structure. The above-mentioned locking structure may be configured to be rereleased by manual pressing, toggling, or pulling, so as to reduce the risk of accidental unlocking caused by cycling vibrations.

After the connecting member C13 is extended, it is connected to the connecting member c23 in a plug-in manner. Specifically, the connecting member c23 is provided with a slot for accommodating the connecting member C13, and the slot is provided with a locking member. After the connecting member C13 is inserted into the slot, it is limited by the locking member, at which time the connecting member C13 and the connecting member c23 remain relatively fixed. When the connection is to be released, first the state of the locking member is changed to release the connecting member C13 from the limited state, at which time the connecting member C13 may be pulled out.

In some embodiments (not shown), the quick-release structure between the connecting member C13 and the connecting member c23 may include a pin hole, an elastic button, a ball locking structure, a claw, a rotating locking sleeve, a cam clamping member, a threaded knob, a pull-ring type locking pin, or a safety buckle. The user can release the lock between the connecting member C13 and the connecting member c23 by pressing, pulling, rotating, or toggling the locking member, thereby achieving quick detachment of the backpack body 1.

To improve connection stability, an anti-rotation mating structure may be provided between the connecting member C13 and the connecting member c23, such as a rounded rectangular cross-section, a non-circular cross-section, a keyway fit, a limiting plane, an anti-rotation protrusion, or an anti-rotation groove. Through the anti-rotation mating structure, even if the backpack body 1 is subjected to lateral swinging or torsional forces during riding, the possibility of the connecting member C13 rotating relative to the connecting member c23 can be reduced.

In some other embodiments, of course, the connecting member C13 and the connecting member c23 may also use other connection methods, such as snap-fit connection, interlocking, threaded connection and the like.

It should be noted that in this embodiment, the specific form of the backpack body includes, but is not limited to, a backpack, a shoulder bag, and a crossbody bag.

Such a design firstly allows the backpack to be firmly fixed to the bicycle during riding without the need to install a rear rack on the bicycle, and without the rider having to carry it, making riding easier; secondly, there is a sufficient gap between the backpack and the seat post to prevent the backpack from interfering with the rider's movements; finally, upon reaching the riding destination, the backpack may be quickly separated from the bicycle, allowing it to be carried away immediately.

### Embodiment 2

This embodiment provides a backpack. Referring to FIG. 1, based on Embodiment 1, for further fixation, the backpack body 1 is further provided with a connecting member A11 and a connecting member B12. The connecting member A11 and the connecting member B12 are respectively disposed on other sides of the side where the connecting member C13 is located, and the connecting member A11 and the connecting member B12 may be connected to each other. In this embodiment, the connecting member A11 and the connecting member B12 are buckles; specifically, the connecting member A11 is a male buckle and the connecting member B12 is a female buckle. The connecting member A11 passes through the bicycle seat and then connects with the connecting member B12, improving the firmness of the backpack body 1 and further preventing the backpack from shaking in different directions (left/right, front/back, up/down, or rotation). It can be understood that the connecting member A11 and the connecting member B12 also have a certain load-bearing effect.

In some other embodiments, the connecting member A11 and the connecting member B12 may also be other structures capable of mating with each other for fixed connection, such as hook docking, tie connection, or hook-and-loop fastener connection. The connection method between the connecting member A11 and the connecting member B12 is well known to those of ordinary skill in the art and will not be described in detail here.

In some embodiments, the connecting member A11 and the connecting member B12 may be disposed on the left and right sides of the backpack body 1, respectively, or may be disposed on the back, front, bottom, side reinforcement straps, or near the roots of the shoulder straps of the backpack body 1. The installation positions of the connecting member A11 and the connecting member B12 may be determined according to the posture of the backpack body 1 when fixed to the bicycle, so that the connecting member A11, the connecting member B12, and the connecting member C13 together form a three-point support, four-point support, or multi-point support.

In some embodiments, a plurality of fixing points may be provided on the backpack body 1, and the plurality of fixing points may include at least two of a fixing point located at the bottom of the backpack body 1, a fixing point located on the left side of the backpack body 1, a fixing point located on the right side of the backpack body 1, a fixing point located on the back of the backpack body 1, and a fixing point located on the front of the backpack body 1. The connecting member A11 and the connecting member B12 can form horizontal connecting straps, lateral connecting straps, or intersecting X-shaped connecting straps between the above-mentioned fixing points to adapt to different sizes of the bicycle saddle 31, seat post 32, and backpack body 1.

### Embodiment 3

This embodiment provides a backpack, as shown in FIG. 1, including a backpack body 1, a connecting member A11 disposed on the left side of the backpack body 1, a connecting member B12 disposed on the right side of the backpack body 1, and a connecting member C13 disposed at the bottom of the backpack body 1. The connecting member A11 is used for detachable connection with a connecting member a21 disposed on the left side of the bicycle saddle 31, the connecting member B12 is used for detachable connection with a connecting member b22 disposed on the right side of the bicycle saddle 31, and the connecting member C13 is used for detachable connection with a connecting member c23 disposed on the seat post 32 of a bicycle. The connection between the connecting member A11 and the connecting member a21, the connection between the connecting member B12 and the connecting member b22, and the connection between the connecting member C13 and the connecting member c23 together constitute the support structure of the backpack body 1, and the connection between the connecting member C13 and the connecting member c23 allows for a gap between the backpack body 1 and the seat post 32.

It should be noted that after the backpack is assembled with the bicycle, the connection between the connecting member C13 and the connecting member c23 can bear the main support load and is used to form a gap between the backpack body 1 and the seat post 32 or the frame, so as to prevent the backpack from interfering with the inner or rear sides of the rider's thighs; the connection between the connecting member A11 and the connecting member a21 and the connection between the connecting member B12 and the connecting member b22 can serve as auxiliary fixation to limit excessive lateral swaying, vertical swinging, or rotation of the backpack during riding. Further, when the connection between the connecting member C13 and the connecting member c23 is not fully engaged or the locking fails, the connection between the connecting member A11 and the connecting member a21 and the connection between the connecting member B12 and the connecting member b22 can also serve as a secondary protection structure to prevent the backpack body 1 from falling off completely.

In this embodiment, to provide a stable and reliable mounting position for the connecting member C13, a base 14 is fixedly provided at the bottom of the backpack body 1. The base 14 is preferably made of plastic. As shown in FIG. 2, a mounting groove 141 is provided on the base 14, with one end of the mounting groove 141 facing the seat post 32 communicating with the exterior. The mounting groove 141 is used to accommodate the connecting member C13. The provision of the base 14 also ensures that the backpack body 1 can remain standing on a flat surface when detached from the bicycle, making it less likely to tip over. To optimize the aesthetics of the base 14, the outer surface of the base 14 may also be covered with fabric.

In some embodiments, the base 14 may be a rigid base, a semi-rigid base, or a composite base formed by a combination of a rigid plate and a soft covering layer. The base 14 may be fixed to the bottom of the backpack body 1 by stitching, riveting, screw connection, hot pressing, bonding, snap-fit connection, or internal/external clamping. The base 14 may also be provided with reinforcing ribs, metal inserts, nut inserts, or load-bearing liners to improve durability when the connecting member C13 is repeatedly pulled, rotated, or inserted.

In some embodiments, the base 14 may be connected to the backpack body 1 as an independent mounting module. The base 14 may be fixed to the backpack body 1 via screws, rivets, buckles, inserts, pressure plates, internal/external clamping members, or a detachable mounting plate. When the base 14, the connecting member C13, or the locking structure wears out, the base 14 may be detached and replaced relative to the backpack body 1.

In some embodiments (not shown), the mounting groove 141 may be configured as an open groove, a semi-enclosed groove, or a storage groove with a cover plate. The opening of the mounting groove 141 may be provided with a soft shielding flap, a flip cover, a sliding cover, or an elastic edge to conceal the connecting member C13 when it is hidden, and to allow the connecting member C13 to extend from the mounting groove 141 when it is deployed. In other embodiments, the mounting groove 141 may be omitted, and the connecting member C13 may be directly connected to the base 14; for example, the connecting member C13 may be rotatably connected to the base 14 via a pivot pin.

In this embodiment, as shown in FIG. 2, the connecting member C13 is specifically a sleeve 131, and the connecting member C23 specifically includes a support rod 232 and a clamping hoop 231. The clamping hoop 231 clamps the seat post 32, one end of the support rod 232 is connected to the clamping hoop 231, the support rod 232 matches the sleeve 131, and the support rod 232 may be inserted directly into the sleeve 131 and locked by a latch.

That is, the fixed connection between connector C13 and connector c23 is achieved by inserting the support rod 232 into the sleeve 131 and locking it with a pin. Connector C13 and connector c23 are preferably made of aluminum alloy. As shown in FIG. 2, the sleeve 131 preferably has a rounded rectangular cross-sectional shape, and the cross-sectional shape and size of the support rod 232 are preferably matched exactly to the sleeve 131. Compared with other shapes, this design provides better strength and rigidity, increases the load-bearing capacity of the sleeve 131, enables it to better withstand loads and resist compression, and simultaneously prevents the backpack from swaying left and right or rotating during riding, thereby optimizing stability. The rounded design can reduce the bending stress concentration generated in the sleeve 131 during use, thus improving its durability and service life.

In some embodiments, after the backpack body 1 is connected to the bicycle, the connector C13 and the connector c23 can jointly define the rearward distance, lateral distance, and height position of the backpack body 1 relative to the seat post 32. The aforementioned distances and positions may be adjusted by the length of the support rod 232, the length of the sleeve 131, the insertion depth, the angle of the mounting groove 141 relative to the backpack body 1, the height position of the clamping hoop 231 on the seat post 32, or the adjustment strap length of the connector A11 and connector B12.

In some embodiments, to balance anti-interference and structural compactness, the portion of the connector c23 extending rearward or rear-laterally from the periphery of the seat post 32 is configured to be no more than 120 mm; the minimum gap between the backpack body 1 and the seat post 32 is configured to be sufficient to prevent the backpack body 1 from contacting the inner or rear side of the rider's thighs. The above dimensions may be adjusted according to different bicycle saddles 31, seat posts 32, backpack body 1 sizes, and rider postures.

It should be noted that the connection method between connector C13 and connector c23 includes, but is not limited to, sleeve docking or buckle docking. In some other embodiments, a threaded connection may be used between the sleeve 131 and the support rod 232 instead of pin locking; in this case, a bearing rotational connection may be used between the support rod 232 and the clamping hoop 231 to achieve the same effect. In some other embodiments, the positions of the sleeve 131 and the support rod 232 may be swapped, i.e., connector C13 specifically is the support rod 232, and connector c23 specifically includes the sleeve 131 and the clamping hoop 231, which can also achieve the same effect.

Furthermore, a first rotating shaft is provided within the mounting groove 141 near the seat post 32, and one end of the sleeve 131 is rotatably sleeved on the first rotating shaft, such that the sleeve 131 can rotate relative to the mounting groove 141 about the axis of the first rotating shaft within a range of 0° to 180°; when the included angle between the sleeve 131 and the mounting groove 141 is 0°, the sleeve 131 is in the retracted state; when the included angle between the sleeve 131 and the mounting groove 141 is 180°, the sleeve 131 is in the extended state.

That is, in this embodiment, the sleeve 131 adopts a rotatable and foldable design. With this design, when the backpack is used separately from the bicycle, the sleeve 131 is completely stored in the mounting groove 141 of the base 14 without being exposed, and the included angle with the mounting groove 141 is 0°; when it is necessary to use the bicycle to carry the backpack, the user can manually rotate the sleeve 131 to an included angle of 180° between the sleeve 131 and the mounting groove 141, at which point it may be aligned with and inserted into the support rod 232, and the connection between the two can then be locked by a pin; the connection between the connecting member A11 and the connecting member a21 and the connection between the connecting member B12 and the connecting member b22 can serve to assist in fixing and prevent the backpack from accidentally falling. After arriving at the riding destination, the connections between the connecting member A11 and the connecting member a21, between the connecting member B12 and the connecting member b22, and between the connecting member C13 and the connecting member c23 are released, and then the sleeve 131 is rotated back to an included angle of 180° with the mounting groove 141, allowing the backpack to be carried away.

It should be noted that in this embodiment, the connecting member C13 is specifically a straight sleeve 131. In some other embodiments, the connecting member C13 may also adopt a structure of an isosceles triangular plate+straight sleeve 131, that is, the straight sleeve 131 is embedded in the perpendicular bisector of the isosceles triangular plate, and the base of the isosceles triangular plate is hinged to the mounting groove 141, so as to achieve a triangular support effect.

It should be noted that in this embodiment, the specific form of the backpack body includes but is not limited to a backpack, a shoulder bag, and a crossbody bag.

In this embodiment, the connection methods that may be used between the connecting member A11 and the connecting member a21, and between the connecting member B12 and the connecting member b22, include but are not limited to buckle connection, hook connection, tie connection, or hook-and-loop fastener connection.

More specifically, as shown in FIG. 1, the connecting member A11, connecting member B12, connecting member a21, and connecting member b22 of this embodiment each include an adjustment strap and a buckle. The length of the adjustment strap is adjustable. One end of the adjustment strap of the connecting member A11 and one end of the adjustment strap of the connecting member B12 are each connected to the buckle, and the other ends are each connected to the backpack body 1. One end of the adjustment strap of the connecting member a21 and one end of the adjustment strap of the connecting member b22 are each connected to the buckle, and the other ends are each connected to the saddle 31. The buckle of the connecting member A11 and the buckle of the connecting member b22 are both male buckles, while the buckle of the connecting member a21 and the buckle of the connecting member B12 are both female buckles. The buckle of the connecting member a21 and the buckle of the connecting member b22 may be engaged with each other.

It should be noted that after the user engages the buckle of the connecting member A11 with the buckle of the connecting member a21, and the buckle of the connecting member B12 with the buckle of the connecting member b22, the adjustment straps of each connecting member may be adjusted so that the connecting members on the left and right sides provide auxiliary tensioning and positioning for the backpack body 1, thereby cooperating with the bottom connecting member to improve the stability of the backpack connection and providing anti-drop protection when the bottom connecting member connection is abnormal.

With this design, not only can the connecting member A11 and the connecting member a21, as well as the connecting member B12 and the connecting member b22, be quickly attached and detached, but the connecting member a21 and the connecting member b22 may also be engaged with each other when the backpack is not mounted, preventing the connecting member a21 and the connecting member b22 from swinging significantly with the bicycle body when the bicycle is used without the backpack, which would otherwise interfere with riding.

This embodiment also provides a backpack connection assembly, as shown in FIG. 1, including the backpack described above, and further including a connecting member a21 for connecting to the left side of the bicycle saddle 31, a connecting member b22 for connecting to the right side of the bicycle saddle 31, and a connecting member c23 for connecting to the seat post 32 of a bicycle, the connection structure under the saddle 31, the seat tube 33, or the rear seat stay 34. The connecting member a21, the connecting member b22, and the connecting member c23 are all fixedly connected to the bicycle, more preferably using a detachable fixed connection, so that they may be replaced in case of local failure or damage.

In some embodiments, the connecting member c23 may be detachably fixed to the seat post 32, seat tube 33, or rear seat stay 34 via a clamping hoop 231, and the connecting member c23 may also be connected to the connection structure under the saddle 31. The clamping hoop 231 may include a first clamping semi-ring and a second clamping semi-ring, which are connected by screws, a quick-release lever, an eccentric clamping member, or a snap-lock member. The inner side of the clamping hoop 231 may be provided with a rubber pad, anti-slip texture, or flexible lining to increase friction with the seat post 32 and reduce wear on the surface of the seat post 32.

In some embodiments, the connecting member a21 and the connecting member b22 may be fixed to the left side, right side, seat rails under the saddle 31, the bottom bracket of the saddle 31, the upper clamp of the seat post 32, or the connection area between the saddle 31 and the seat post 32. The connecting member a21 and the connecting member b22 may be installed by strap wrapping, clamp gripping, screw fastening, snap-fit fastening, or interlocking with the bottom structure of the seat cushion, so as to adapt to different vehicle models.

### Embodiment 4

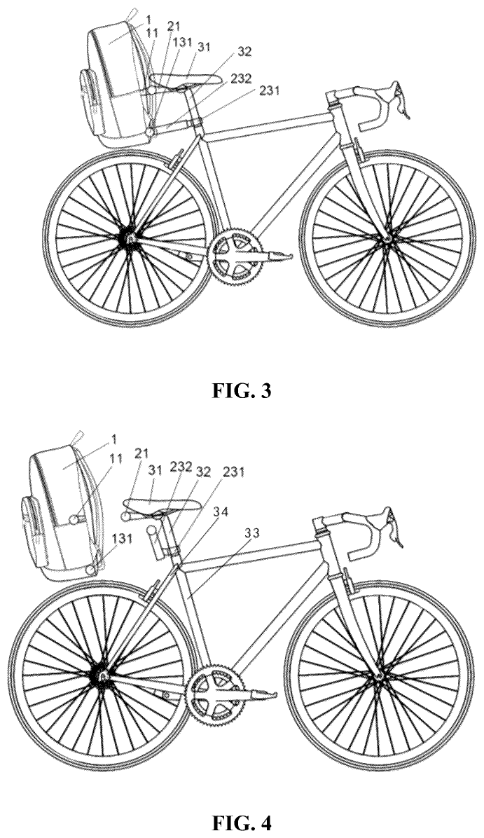

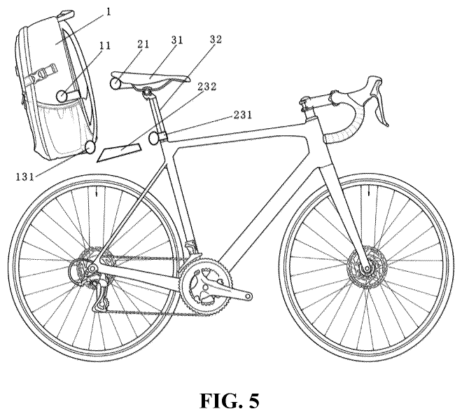

This embodiment provides a backpack, as shown in FIGS. 3 to 4, which is substantially the same as the backpack provided in Embodiment 3, with the differences being:

In this embodiment, the sleeve 131 is fixed within the mounting groove 141; one end of the support rod 232 is hinged to the clamping hoop 231, and the support rod 232 can rotate relative to the seat post 32 within a range of 0-90°, with the support rod 232 being limit-locked when forming an included angle of 0° and 90° with the seat post 32.

That is, in this embodiment, the sleeve 131 adopts a fixed design, while the support rod 232 adopts a rotatable and foldable design; with this design, when the bicycle needs to carry the backpack, the user can rotate the support rod 232 to form an included angle of 90° with the seat post 32. At this time, the support rod 232 faces the sleeve 131 horizontally set in the mounting groove 141, allowing the backpack to be moved so that the sleeve 131 fits over the support rod 232, and the connection between the two is locked by a pin. The connection between the connecting member A11 and the connecting member a21, as well as the connection between the connecting member B12 and the connecting member b22, can serve to assist in fixing the backpack. After reaching the destination, the connections between the connecting member A11 and the connecting member a21, between the connecting member B12 and the connecting member b22, and between the connecting member C13 and the connecting member c23 are released, and then the support rod 232 is rotated back to an included angle of 0 with the seat post 32, which reduces the presence of the support rod 232 and allows the backpack to be carried away directly.

In some embodiments, as shown in FIGS. 3 and 5, the support rod 232 may be configured as an independent separation rod, with one end of the support rod 232 detachably connected to the sleeve 131, and the other end detachably connected to the clamping hoop 231 or the seat post side connection seat. When the backpack body 1 is connected to the bicycle, the support rod 232 is connected between the sleeve 131 and the clamping hoop 231 to maintain a preset gap between the backpack body 1 and the seat post 32; when the backpack body 1 is separated from the bicycle, the support rod 232 may be detached from the sleeve 131 and the clamping hoop 231 respectively, so that the support rod 232 is in a separated state relative to both the backpack body 1 and the bicycle. Thus, when the backpack is not mounted, there is no need to retain an outwardly protruding rod-like structure on the bicycle side, and the exposed presence of the clamping hoop 231 or the seat post side connection seat may be reduced, thereby balancing aesthetic simplicity and reducing the possibility of the exposed structure interfering with the rider or external objects.

### Embodiment 5

This embodiment provides a backpack, which may be construed with reference to the connection relationships in Embodiments 1 to 4, with the difference that the connecting member C13 adopts a foldable or multi-rod unfolding structure. The connecting member C13 may include a first connecting rod and a second connecting rod; one end of the first connecting rod is hinged to the base 14 or the mounting groove 141, the other end of the first connecting rod is hinged to the second connecting rod, and the free end of the second connecting rod forms a plug-in end, a sleeve end, or a locking end for mating with the connecting member C23. When the backpack body 1 is separated from the bicycle, the first connecting rod and the second connecting rod may be folded and stored in the mounting groove 141 or the storage cavity of the backpack body 1; when it is necessary to connect to the bicycle, the first connecting rod and the second connecting rod unfold to form a connecting arm extending toward the seat post 32.

In some embodiments (not shown), the connecting member C13 may also adopt a rotating extension structure. The rotating extension structure may include a single-rod rotating structure or a double-rod rotating structure. In the single-rod rotating structure, a single connecting rod rotates around a rotating shaft provided on the base 14 and locks in the unfolded position; in the double-rod rotating structure, two connecting rods rotate around their respective rotating shafts, or rotate synchronously through a synchronous connecting member, so as to form two support points arranged at intervals at the bottom of the backpack body 1, thereby improving the torsional resistance of the backpack body 1 after connection.

In some embodiments (not shown), the connecting member C13 may also adopt a flip-plate structure. The flip-plate structure may include a triangular connecting plate, a trapezoidal connecting plate, or a plate-like connecting member with reinforcing ribs; one side of the plate-like connecting member is hinged to the base 14, and a sleeve 131, a plug-in hole, or a locking seat is provided on the side of the plate-like connecting member away from the hinged side. After being unfolded, the plate-like connecting member can form surface contact or triangular support with the base 14 to improve the ability of the connecting member C13 to withstand vertical loads and torsional loads.

In some embodiments (not shown), the connecting member C13 may also adopt an X-shaped cross-extension structure. The X-shaped cross-extension structure may include a first cross rod and a second cross rod that cross each other and are hinged in the middle; the inner ends of the first cross rod and the second cross rod are slidably or hingedly connected to the base 14, and the outer ends are jointly connected to a plug-in seat or a sleeve 131. In order to improve the strength of the X-shaped cross-extension structure, a bottom telescopic connection structure, a linear guide rail, or a limiting groove may also be provided on the base 14 to limit the relative swinging of the first cross rod and the second cross rod after unfolding.

### Embodiment 6

This embodiment provides a backpack connection assembly, which may be construed with reference to Embodiment 3 and Embodiment 4, with the difference that the number and positions of connection points between the backpack body 1 and the bicycle may be combined as needed. Two, three, four, or five connection points may be provided on the backpack body 1, and the multiple connection points may be located respectively on the inside, bottom, left side, right side, front side, back side, or near the base of the shoulder straps of the backpack body 1. Corresponding connecting parts on the bicycle may be provided on the left side of the saddle 31, the right side of the saddle 31, the bottom of the saddle 31, the side of the seat post 32, the rear of the seat post 32, or the upper clamp of the seat post 32, the seat tube 33, or the rear seat stay 34.

In some embodiments, after the backpack body 1 is connected to the bicycle, it may be arranged horizontally, vertically, or inclined relative to the seat post 32. The relative lengths between connecting part A11 and connecting part a21, connecting part B12 and connecting part b22, and connecting part C13 and connecting part c23 may be adjusted to maintain a gap between the lower part of the backpack body 1 and the seat post 32, while keeping the upper part of the backpack body 1 close to the area behind or below the saddle 31, thereby balancing load-bearing stability and clearance for riding.

In some embodiments, the backpack body 1 may be a soft bag, a semi-rigid bag, or a bag with a rigid base. For a soft bag, a rigid inner lining or base 14 may be provided at the position of the connecting part C13 to improve connection stability; for a semi-rigid bag or a bag with a rigid base, the connecting part C13 may be directly fixed to the rigid base, rigid bottom plate, or an integrally formed mounting seat.

### Embodiment 7

In some embodiments, the aforementioned backpack body 1 may be replaced by other carrying devices capable of carrying items or objects, such as a rigid case, semi-rigid storage box, tool box, tent bag, child seat, or other load-carrying devices that may be installed near the seat post 32 of a bicycle, the connection structure below the saddle 31, the seat tube 33, or the rear seat stay 34. In this case, the cooperative relationship between the base 14, the connecting part C13, the connecting part a21, the connecting part b22, and the connecting part c23 may be the same as in the aforementioned backpack embodiments.

In the description of the present disclosure, it should be understood that directional terms such as “front, back, upper, lower, left, right,” “transverse, vertical, perpendicular, horizontal,” and “top, bottom,” generally refer to the orientations or positional relationships shown in the accompanying drawings. They are used only for the convenience of describing the present disclosure and simplifying the description. Unless otherwise specified, these directional terms do not indicate or imply that the device or element referred to must have a specific orientation or be constructed and operated in a specific orientation, and therefore should not be construed as limiting the scope of protection of the present disclosure. The directional terms “inner, outer” refer to the inside and outside relative to the profile of each component itself.

For ease of description, spatial relative terms such as “on,” “above,” “upper surface,” “upper,” may be used herein to describe the spatial relationship of one device or feature to other devices or features as illustrated in the figures. It should be understood that the spatial relative terms are intended to encompass different orientations of the device in use or operation in addition to the orientation depicted in the figures. For example, if a device in the FIGS. is inverted, a device described as being “above” or “on” other devices or structures would then be oriented as “below” or “beneath” the other devices or structures. Thus, the exemplary term “above” can encompass both “above” and “below” orientations. The device may also be oriented in other ways (rotated 90 degrees or at other orientations), and the spatial relative descriptions used herein should be interpreted accordingly.

Furthermore, it should be noted that the use of terms such as “first”, “second” to define components is merely for the purpose of distinguishing the corresponding components, and unless otherwise stated, these terms do not have special meanings. Therefore, they should not be construed as limiting the scope of protection of the present disclosure.

The above descriptions are merely preferred embodiments of the present disclosure and are not intended to limit the present disclosure. For those skilled in the art, various modifications and changes can be made to the present disclosure. Any modification, equivalent substitution and improvement made within the spirit and principles of the present disclosure shall be included within the scope of protection of the present disclosure.

What is claimed is:

1. A connection base assembly for a bicycle, comprising:
a base, the base being configured for fixing to an interior, a bottom, a back, or any side of a carrying device;
a first mounting accessory, the first mounting accessory being provided on the base, and the first mounting accessory being configured to be capable of switching between an extended state and a retracted state; and
a second mounting accessory, the second mounting accessory being configured for mounting to a seat post, an under-saddle connection structure, a seat tube, or a rear seat stay of a bicycle;
wherein the first mounting accessory is detachably connected to the second mounting accessory in the extended state, and after the first mounting accessory is connected to the second mounting accessory, a gap is formed between the carrying device and the seat post; and
the first mounting accessory is at least partially accommodated within the carrying device or the base, or attached to one side of the carrying device or the base, in the retracted state.

2. The connection base assembly according to claim 1, wherein a mounting groove is provided on the base, an end of the mounting groove facing the seat post is open, and the mounting groove is configured for accommodating at least a portion of the first mounting accessory.

3. The connection base assembly according to claim 2, wherein the first mounting accessory is provided in the mounting groove in a sliding manner or a rotating manner to switch between the extended state and the retracted state.

4. The connection base assembly according to claim 3, wherein the first mounting accessory is slidably provided in the mounting groove, the first mounting accessory slides along a length direction of the mounting groove, and the first mounting accessory is allowed to be limited and locked at an end point of a sliding stroke.

5. The connection base assembly according to claim 3, wherein a rotating shaft is provided in the mounting groove, one end of the first mounting accessory is rotatably connected to the rotating shaft, and the first mounting accessory is configured to rotate relative to the mounting groove with the rotating shaft as an axis within a range of 0° to 180°; and
when an included angle between the first mounting accessory and the mounting groove is 0°, the first mounting accessory is in the retracted state; when the included angle between the first mounting accessory and the mounting groove is 180°, the first mounting accessory is in the extended state.

6. The connection base assembly according to claim 1, wherein one of the first mounting accessory and the second mounting accessory comprises a sleeve, and the other comprises a rod member matching the sleeve, the rod member being insertable into the sleeve to achieve a detachable connection.

7. The connection base assembly according to claim 6, wherein a locking member is further provided between the first mounting accessory and the second mounting accessory, the locking member is configured to fix the first mounting accessory and the second mounting accessory relative to each other after the rod member is inserted into the sleeve, and the locking member is capable of being manually operated to release a relative fixation.

8. The connection base assembly according to claim 6, wherein the sleeve has a non-circular cross-section, and a cross-sectional shape of the rod member matches the sleeve to restrict relative rotation between the rod member and the sleeve when the sleeve and the rod member are connected.

9. The connection base assembly according to claim 1, wherein the second mounting accessory comprises a seat post side connection seat and an independent separation rod, one end of the independent separation rod is detachably connected to the first mounting accessory, and the other end is detachably connected to the seat post side connection seat.

10. The connection base assembly according to claim 1, wherein the second mounting accessory comprises a clamping hoop configured for clamping the seat post, the clamping hoop comprises a first clamping semi-ring and a second clamping semi-ring, and the first clamping semi-ring and the second clamping semi-ring are connected by a fastener.

11. The connection base assembly according to claim 1, wherein the base is fixed to the interior, the bottom, the back, or any side of the carrying device by means of stitching, riveting, screw connection, bonding, or snap-fit connection.

12. The connection base assembly according to claim 1, wherein the carrying device is a backpack, a rigid case, a semi-rigid storage box, a tool box, a tent bag, or a child seat.

13. A backpack connection assembly, comprising:
a backpack body;
a base, the base being fixed to an interior, a bottom, a back, or any side of the backpack body;
a first mounting accessory, the first mounting accessory being provided on the base, the first mounting accessory being configured to be switchable between an extended state and a retracted state;
a second mounting accessory, the second mounting accessory being configured for mounting to a seat post or an under-saddle connection structure of a bicycle, the first mounting accessory being detachably connected to the second mounting accessory in the extended state, and a gap being formed between the backpack body and the seat post after the first mounting accessory and the second mounting accessory are connected;
a first auxiliary connecting member provided on a first side of the backpack body, for detachably connecting with a corresponding auxiliary connecting member provided on a left side of the bicycle saddle; and
a second auxiliary connecting member provided on a second side of the backpack body, for detachably connecting with a corresponding auxiliary connecting member provided on a right side of the bicycle saddle;
wherein a connection of the first auxiliary connecting member with the corresponding auxiliary connecting member, a connection of the second auxiliary connecting member with the corresponding auxiliary connecting member, and a connection of the first mounting accessory with the second mounting accessory together constitute a support structure of the backpack body.

14. The backpack connection assembly according to claim 13, wherein each of the first auxiliary connecting member and the second auxiliary connecting member comprises an adjustable connecting strap and a buckle member, and the adjustable connecting strap has an adjustable length.

15. The backpack connection assembly according to claim 14, further comprising a first corresponding auxiliary connecting member configured to be disposed on a first side of a bicycle saddle and detachably connected to the first auxiliary connecting member;
a second corresponding auxiliary connecting member configured to be disposed on a second side of the bicycle saddle and detachably connected to the second auxiliary connecting member;
the buckle member of the first auxiliary connecting member and the buckle member of the second corresponding auxiliary connecting member are both of a first type, the buckle member of the second auxiliary connecting member and the buckle member of the first corresponding auxiliary connecting member are both of a second type, and the first type buckle member and the second type buckle member are capable of being buckled with each other.

16. The backpack connection assembly according to claim 13, wherein a buckle connection, a hook connection, a tie connection, or a hook-and-loop fastener connection is adopted between the first auxiliary connecting member and the corresponding auxiliary connecting member, and between the second auxiliary connecting member and the corresponding auxiliary connecting member.

17. The backpack connection assembly according to claim 13, wherein the second mounting accessory is disposed on the under-saddle connection structure, the seat tube, or the rear seat stay of the bicycle.

18. The backpack connection assembly according to claim 13, wherein the base is fixed to the interior, the bottom, the back, or any side of the backpack body by means of stitching, riveting, screw connection, bonding, or snap-fit connection.

19. The backpack connection assembly according to claim 13, wherein a minimum gap between the backpack body and the seat post is configured to be sufficient to prevent the backpack body from contacting a rider's body.

20. The backpack connection assembly according to claim 19, wherein a length by which the second mounting accessory extends rearward from a periphery of the seat post is not greater than 120 mm.
